(19) United States
(12) Patent Application Publication
(10) Pub. No.: US 2016/0119166 A1
(43) Pub. Date: Apr. 28, 2016

(54) METHOD AND APPARATUS FOR PROVIDING GATEWAY FUNCTION

(71) Applicant: ELECTRONICS AND TELECOMMUNICATIONS RESEARCH INSTITUTE, Daejeon (KR)

(72) Inventors: Myung-Ki SHIN, Seoul (KR); Hyoung-Jun KIM, Daejeon (KR); Yong-Geun HONG, Daejeon (KR)

(21) Appl. No.: 14/923,627

(22) Filed: Oct. 27, 2015

(30) Foreign Application Priority Data
Oct. 28, 2014 (KR) 10-2014-0147149
Oct. 16, 2015 (KR) 10-2015-0144797

(51) Int. Cl. H04L 12/66; H04L 29/08; H04L 29/06

(52) U.S. Cl. CPC H04L 12/66; H04L 69/18; H04L 67/12

(57) ABSTRACT

Disclosed herein is a method and apparatus for providing a gateway function. The gateway function may be provided through interaction between a gateway and a server. In providing the gateway function, the gateway may provide a relatively lower layer, and the server may provide a relatively upper layer. The server may provide a gateway function in an NFV manner. The gateway may perform processing by calling a mapping function of the NFV type provided by the server. The server may be one of cloud servers providing an NFV pool.

### CROSS REFERENCE TO RELATED APPLICATIONS

This application claims the benefit of Korean Patent Application Nos. 10-2014-0147149, filed Oct. 28, 2014 and 10-2015-0144797, filed Oct. 16, 2015, which are hereby incorporated by reference in their entirety into this application.

### BACKGROUND OF THE INVENTION

1. Technical Field

The present invention generally relates to a method and apparatus for communication, and more particularly, to a method and apparatus for providing a gateway function.

2. Description of the Related Art

As well known to those skilled in the art, gateways are used for providing interaction between nodes and the Internet in a low-power, resource-constrained network environment. As an example of such a low-power, resource-constrained network environment, there is an Internet of Things (IoT).

For such a gateway, a gateway to network adaptation mapping function, etc. is statically implemented on gateway hardware. As the gateway to network adaptation mapping function, there are 6lo adaptation, CoAP-to-HTTP mapping, and DICE-to-TLS mapping, etc. As the 6lo adaptation, there is 6LoWPAN.

When the gateway to network mapping function, etc. is statically implemented, it is necessary to upgrade the entire software on the gateway hardware to a new version of the software. In addition, in order to add a new networking function, it is required to additionally install a physical gateway or to physically relocate the gateway. In addition, in order to make settings for processing pre-determined networking functions in sequence, it is necessary to additionally install a physical gateway or to relocate the gateway. Such additional installation or direct relocation causes inconvenience.

For example, when specific gateway functions are processed in the order of (1) IoT packet analysis, namely, deep packet inspection (DPI), (2) 6lo adaptation, (3) CoAP-to-HTTP mapping, and (4) DICE-to-TLS mapping, it is required to directly and physically relocate the gateway or the like in order to dynamically change the specific functions in the order of (1) DPI, (2) 6lo adaptation, (3) CoAP-to-HTTP mapping, and (4) DICE-to-TLS mapping.

In the IoT environment, it is necessary to support interaction with the global Internet through dynamic connections between various objects and flexible connections for performing various network functions. Accordingly, the additional installation or direct relocation requirement, as described above, may cause a large problem in the IoT environment.

U.S. Patent Application Publication No. 2014/0317261 discloses virtualization in a networking environment. U.S. Patent Application Publication No. 2014/0317261 presents a technique for implementing a virtualized network function in one or more physical computers in order to provide a virtualized network service.

### SUMMARY OF THE INVENTION

Accordingly, the present invention has been made keeping in mind the above problems occurring in the prior art, and an object of the present invention is to provide an apparatus and method for implementing a gateway function, required in IPv6, over a network of resource-constrained nodes.

Another object of the present invention is to provide an apparatus and method for supporting interaction with a global network such as the Internet in a low-power, resource-constrained networking environment such as an IoT environment.

A further object of the present invention is to provide an apparatus and method for more extensively and flexibly supporting interaction with a global network such as the Internet in a low-power, resource-constrained networking environment.

Yet another object of the present invention is to provide an apparatus and method for processing a gateway function through a network function virtualization (NFV) concept.

In order to accomplish the above objects, the present invention provides a method for providing, by a gateway, a gateway function. The method includes receiving an input packet from a node and providing the gateway function for the input packet by using a first networking function provided by the gateway and a second networking function provided by a server.

The gateway may receive the input packet from the node through a first interface of the gateway, and the first interface may be a wireless network interface.

Providing the gateway function may include transmitting an output packet, generated by applying the gateway function to the input packet, to an external node through a second interface of the gateway.

The server may transmit the output packet to the second interface, and the second interface may transmit the output packet to the external node.

The networking function provided for the first interface and the networking function provided for the second interface may be different from each other.

Providing the gateway function may further include: transmitting, to the server, a request for the second networking function for the input packet, receiving, from the server, the result of processing the request, and generating the output packet based on the processing result.

The first networking function may include media access control (MAC), and the second networking function may include 6lo adaptation.

The first networking function may include user datagram protocol (UDP), and the second networking function may include at least one of CoAP-to-HTTP, DICE-to-TLS and ACE mapping functions.

The node may not directly support an IP connection, the first networking function may include MAC, and the second networking function may include an IP.

The server may provide the second networking function in a network function virtualization (NFV) type.

The second networking function may be provided on a virtualization layer provided by the server.

The server may be one of cloud servers providing an NFV pool.

The processing capacity of the cloud may be expanded by adding a new server, which provides the second networking function, to the cloud.

The gateway may process the input packet in software through a mapping function in a virtualized manner regardless of whether the input packet is an IP packet or a non-IP packet by forwarding the input packet to the server regardless of whether the input packet is an IP packet or a non-IP packet.

In another aspect, the present invention provides a gateway including: a first interface, receiving an input packet from a node, a second interface, transmitting an output packet to an external node, and a processing unit, providing a gateway function for the input packet by using a first networking function provided by the gateway and a second networking function provided by a server, wherein the output packet is generated by applying the gateway function to the input packet.

In still another aspect, the present invention provides a method for providing, by a server, a gateway function. The method includes: receiving, from a gateway, a request for a first networking function for an input packet received by the gateway, processing the first networking function corresponding to the request, and transmitting a response to the request to the gateway, wherein the gateway function for the input packet is provided by a second networking function, provided by the gateway, and the first networking function.

The second networking function may include MAC, and the first networking function may include 6lo adaptation.

The second networking function may include UDP, and the first networking function may include at least one of CoAP-to-HTTP, DICE-to-TLS, and ACE mapping functions.

The server may provide the first networking function in an NFV type.

The server may be one of cloud servers providing an NFV pool.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates a gateway function for supporting end-to-end networking of resource-constrained nodes;

FIG. 2 is a configuration diagram of a system for providing a gateway function according to an embodiment of the present invention;

FIG. 3 is a structural diagram of a gateway according to an embodiment of the present invention;

FIG. 4 is a structural diagram of a server according to an embodiment of the present invention;

FIG. 5 illustrates a gateway function for supporting end-to-end networking of resource-constrained nodes according to an embodiment of the present invention;

FIG. 6 illustrates a gateway function for supporting end-to-end networking of resource-constrained nodes according to another embodiment of the present invention;

FIGS. 7A and 7B illustrate communication entities and networking functions of the entities in the case where a node according to an embodiment of the present invention directly supports an IP connection, wherein FIG. 7A illustrates communication entities according to an embodiment of the present invention, and FIG. 7B illustrates a networking function of each entity according to an embodiment of the present invention;

FIGS. 8A and 8B illustrate communication entities and networking functions of the entities in the case where a node according to an embodiment of the present invention does not directly support an IP connection, wherein FIG. 8A illustrates communication entities according to an embodiment of the present invention, and FIG. 8B illustrates the networking functions of respective entities according to an embodiment of the present invention; and

FIG. 9 is a flowchart of a method for providing a gateway function by a gateway and a server according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. In the drawings, like numerals refer to the same or similar elements throughout the several views. The shapes, sizes, etc. of components in the drawings may be exaggerated to make the description clearer.

In the following detailed description, reference is made to the accompanying drawings that show, by way of illustration, specific embodiments in which the present invention may be practiced. These embodiments are described in sufficient detail to enable those skilled in the art to practice the present invention. It is to be understood that the various embodiments of the present invention, although different, are not necessarily mutually exclusive. For example, a particular feature, structure or characteristic described herein in connection with one embodiment may be implemented within other embodiments without departing from the spirit and scope of the present invention. In addition, it is to be understood that the location or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled.

Hereinafter, various preferred embodiments of the present invention will be described in more detail with reference to the accompanying drawings so that a person skilled in the art can easily practice the invention.

Firstly, the abbreviations used in the description of the embodiments will be defined.

Internet Protocol Version 6: IPv6

IPv6 over Networks of Resource-constrained Nodes: 6lo

IPv6 over Low power Wireless Personal Area Networks: 6LoWPAN

Constrained Application Protocol: CoAP

Hypertext Transfer Protocol: HTTP

Datagram Transport Layer Security: DTLS

DTLS In Constrained Environments: DICE

Transport Layer Security: TLS

Internet of Things: IoT

Deep Packet Inspection: DPI

Media Access Control: MAC

User Datagram Protocol: UDP

Transmission Control Protocol: TCP

Near Field Communication: NFC

Long Term Evolution: LTE

Network Function Virtualization: NFV

Network Address Translation: NAT

Authentication and Authorization for Constrained Environments: ACE

Virtual machine: VM

Wireless Personal Area Network: WPAN

In addition, hereinafter, ‘X mapping” and “X function,” related to a gateway function, may be abbreviated as “X”. And, hereinafter, a term “mapping” may be replaced with a term “translation”.

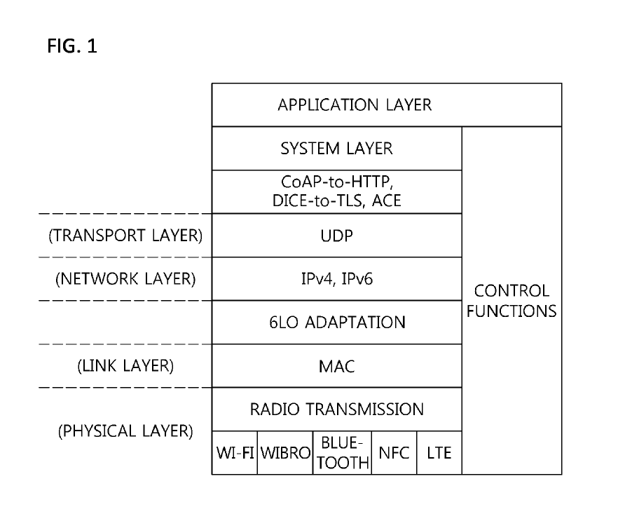

FIG. 1 illustrates a gateway function for supporting end-to-end networking of resource-constrained nodes.

A function structure for supporting end-to-end networking of resource-constrained nodes may include at least one of an interface, radio transmission, MAC, 6lo adaptation, IPv6, UDP, mapping functions (e.g. CoAP-to-HTTP, DICE-to-TLS and/or ACE, etc.), a system layer, and an application layer.

In FIG. 1, the horizontal box may represent an entity of a gateway function for supporting end-to-end networking of resource-constrained nodes. For example, the entity may be a layer. The entity located on the top portion may be an upper layer entity, in contrast with an entity located on the bottom portion.

UDP may correspond to a transport layer. IPv4 and/or IPv6 may correspond to a network layer. 6lo adaptation may correspond to an IPv6 adaptation layer. MAC may correspond to a link layer. The radio transmission and interface may correspond to a physical layer.

In the function structure, the interface may be located undermost. For example, the interface may be a wireless interface for supporting a local area network (LAN) with hardware. For example, the wireless interface may include at least one of Wi-Fi, WiBro, Bluetooth, NFC, and LTE. Here, Wi-Fi may be low-power Wi-Fi. In FIG. 1, as the interface, Wi-Fi, WiBro, Bluetooth, NFC, and LTE are exemplarily illustrated.

The gateway function may configure an IPv4 stack and/or an IPv6 stack as a network layer. In addition, 6lo adaptation may exist between the physical layer and the network layer. 6lo adaptation may compress a header of an IPv6 packet. In addition, the IPv6 packet may be mapped to a LAN packet by 6lo adaptation.

As the protocol for the transport layer, UDP may be used instead of TCP, which has a complex configuration. However, the embodiments below do not preclude the use of TCP.

In the upper layer of a UDP stack, an application transport protocol such as CoAP may be implemented. In addition, for mapping between CoAP and the existing HTTP protocol, a CoAP-to-HTTP mapping function may be provided. In order to provide a security function, a DICE protocol, which supports security communication between resource-constrained nodes, may be implemented. In addition, for mapping between the DICE and existing TLS protocol, a DICE-to TLS mapping function may be provided. In FIG. 1, the CoAP-to-HTTP, DICE-to-TLS, and ACE mapping functions are illustrated. Hereinafter, the term “mapping function” may be omitted.

In the upper layer of the mapping function, the system layer for the overall system operation may be implemented. In addition, the application layer for required applications may be implemented in the uppermost layer.

In order to control the above-described communication protocol functions, control functions may be vertically formed across all of the above-described layers.

The gateway function structure for supporting end-to-end networking of the above-described resource-constrained nodes allows all networking functions to be statically implemented in hardware. Accordingly, in order to upgrade them to a new software version, it is necessary to upgrade all of the software on the gateway hardware. In addition, in order to add a new networking function, it is necessary to additionally install a physical gateway or to physically relocate the gateway. In addition, in order to make settings for processing pre-determined networking functions in sequence, it is also necessary to additionally install a physical gateway or to directly relocate the gateway. Such additional installation or direct relocation causes inconvenience.

NFV may be a technique that is applied to virtualization of middle box functions, such as a firewall and NAT. In order to address the above-described problem, a structure is proposed which enables the NFV concept to be applied to a resource-constrained networking environment through embodiments to be described below.

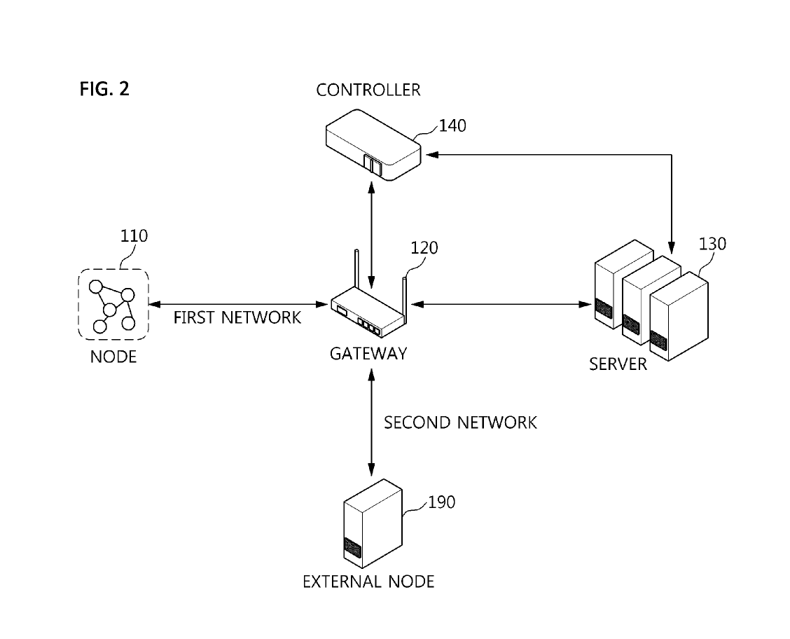

FIG. 2 is a configuration diagram of a system for providing a gateway function according to an embodiment of the present invention.

The system may include a node 110, a gateway 120, a server 130, and a controller 140.

The node 110 may be a resource-constrained node. For example, the node 110 may be an IoT thing. The node 110 may communicate with an external node 190 through a gateway function provided by the gateway 120 and the server 130.

The gateway 120 may provide the gateway function to the node 110. The gateway 120 may provide the gateway function to nodes connected through each of two or more networks. The gateway 120 may provide the gateway function between first and second networks.

The server 130 may provide a gateway function together with the gateway 120. In other words, the gateway 120 and the server 130 may provide at least a part of the above-described gateway function described with reference to FIG. 1. In addition, the gateway function may be provided through interaction between the gateway 120 and the server 130.

The server 130 may be a general-purpose server. The server 130 may provide a virtualization-providing environment, such as a hypervisor, and may provide a VM in the virtualization-providing environment.

The controller 140 may control the gateway 120 and/or the server 130. The controller 140 may be a software-defined network (SDN) controller.

The node 110 and the gateway 120 may be connected through the first network. The gateway 120 and the server 130 may be connected through the first network or a separate network. The gateway 120 and the controller 140 may be connected through the first network or a separate network.

The external node 190 and the gateway 120 may be connected through the second network.

Each of the node 110, gateway 120, server 130, and external node 190 may be present in plural numbers. The plurality of servers may configure a cloud.

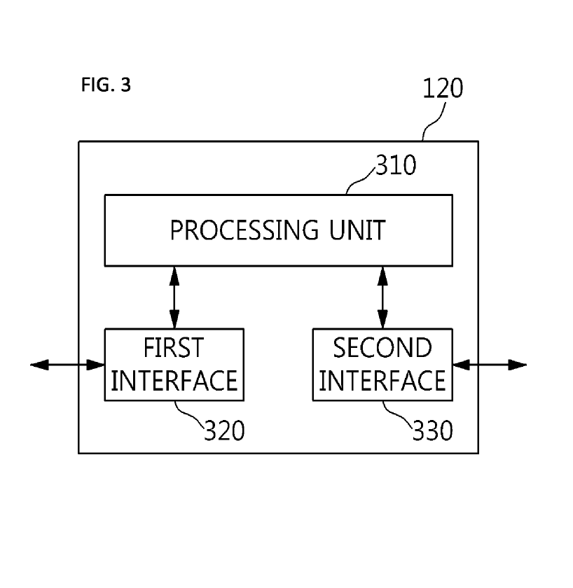

FIG. 3 is a structural diagram of a gateway according to an embodiment of the present invention.

The gateway 120 may provide a processing unit 310, a first interface 320, and a second interface 330.

The processing unit 310 may process tasks required for the operation of the gateway 120. In an example, the processing unit 310 may include at least one processor. The processing unit 310 may execute code for steps or operations of the gateway 120 described in the embodiments.

The first interface 320 may be an interface for communication of the gateway 120. The gateway 120 may be connected to the first network through the first interface 320. The first interface 320 may receive data or information, required for the steps or operations of the gateway 120 described in the embodiments, and may transmit data or information required for the steps or operations of the gateway 120. The first interface 320 may transmit data to another device or may receive data from another device in the first network. For example, the first interface 320 may be a network chip or port.

The second interface 330 may be an interface for communication of the gateway 120. The gateway 120 may be connected to the second network through the second interface 330. The second interface 330 may receive data or information required for the steps or operations of the gateway 120 described in the embodiments, and may transmit data or information required for the steps or operations of the gateway 120. The second interface 330 may transmit data to another device or receive data from another device in the second network. For example, the second interface 330 may be a network chip or port.

Each of the first and second interfaces 320 and 330 may be a part of the interface described with reference to FIG. 1. Each of the first and second interfaces 320 and 330 may be one of Wi-Fi, Wibro, Bluetooth, NFC, and LTE.

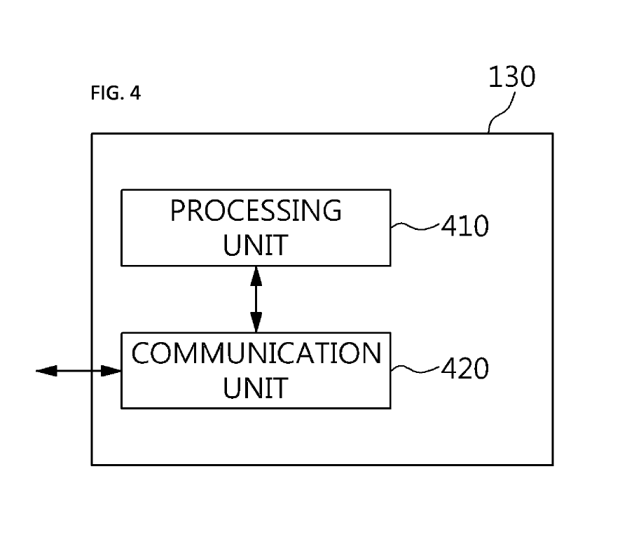

FIG. 4 is a structural diagram of a server according to an embodiment of the present invention.

The processing unit 410 may process tasks required for the operation of the server 130. In an example, the processing unit 410 may include at least one processor. The processing unit 310 may execute code for implementing steps or operations of the server 130 described in the embodiments.

The communication unit 420 may be an interface for communication of the server 130. The communication unit 130 may receive data or information required for the steps or operations of the server 130 described in the embodiments, and may transmit data or information required for the steps or operations of the server 130. For example, the communication unit 420 may be a network chip or port.

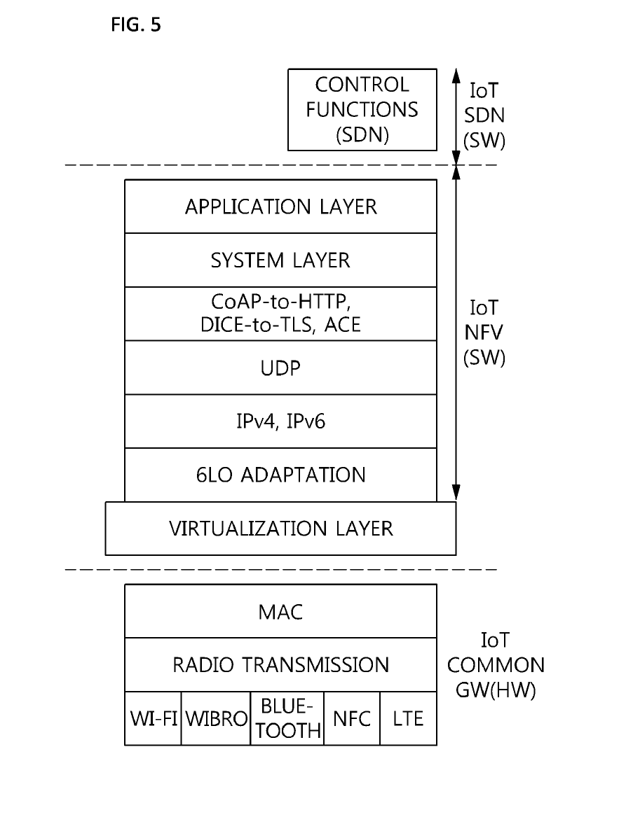

FIG. 5 illustrates a gateway function for supporting end-to-end networking of resource-constrained nodes according to an embodiment of the present invention.

In FIG. 5, the gateway functions are divided into three regions by the dashed lines. Each region may represent the entity of the system in which that part of the gateway function is implemented.

An IoT common gateway (GW) may represent a gateway function provided by the gateway 120 in order to support end-to-end networking of the resource-constrained node. The IoT common GW 120 may be the gateway function implemented in the gateway 120.

In the gateway 120, MAC or lower-layer entities, among entities for providing the gateway function, may be implemented. The IoT common GW may correspond to at least one of the interface, radio transmission, and MAC. For example, the IoT common GW may include at least one of the physical layer and the link layer.

The IoT common GW may be implemented in hardware or mainly in hardware. For example, in the gateway 120, only software related to the interface provided in the gateway 120 may be implemented. In greater detail, in the gateway 120, only software related to the first and second interfaces 320 and 330 may be implemented. Herein, the interface-related software may be a protocol for the interface or a protocol directly corresponding to the interface.

The interface-related software may be software of an entity depending on the interface among entities for providing the gateway function. For example, the interface-related software may include radio transmission software and MAC software.

IoT NFV may represent a gateway function provided by the server 130 in order to support end-to-end networking of the resource-constrained nodes. The IoT NFV may be a gateway function implemented in the server 130.

The IoT NFV may correspond to at least one of IPv4, IPv6, UDP, CoAP-to-HTTP, DICE-to-TLS, ACE, a system layer, and an application layer.

The IoT NFV may be a gateway function implemented in the server 130. In the server 130, entities of the application layer or lower layers, or entities of 6lo adaptation or upper layers, among entities for providing the gateway function, may be implemented.

The IoT NFV may be implemented in software. The IoT NFV may be implemented as a VM. In other words, the server 130 may provide the IoT NFV in the form of a VM running on the server 130. For the VM, the server 130 may provide a virtualization layer. The IoT NFV may be implemented to be operated on the virtualization layer. Alternatively, the IoT NFV may be provided at the virtualization layer.

The VM provided by the server 130 may be present in a plural number. Each of the plurality of VMs may provide a part of the gateway function. The parts of the gateway function provided by the plurality of VMs may be different from each other. For example, the plurality of VMs may respectively provide 6lo adaptation, CoAP-to-HTTP mapping, and DICE-to-TLS mapping.

As explained about the IoT common GW and IoT NFV, a gateway structure for providing the gateway function may be divided into a hardware structure and a software structure using the NFV concept. Here, the hardware structure may correspond to the IoT common GW, and the software structure may correspond to the IoT NFV. These divided structures may be suitable for a low-power, resource-constrained networking environment such as an IoT environment.

In addition, through the NFV concept, a gateway function capable of being processed in software may be provided by the server 130 in a cloud through virtualization.

The control functions described with reference to FIG. 1 may be separated from the gateway 120 and the server 130. The IoT SDN may represent control functions required for supporting the end-to-end networking of the resource-constrained nodes. The IoT SDN may be control functions implemented in the controller 140.

The controller 140 may externally control the VM of the server 130 through the control functions. Here, the control may include installation, connection, management, setting, configuration, operation, etc. The controller 140 may control 6lo adaptation, CoAP-to-HTTP, and DICE-to-TLS mapping through the control functions.

The control functions may be set through a data modeling language. For example, the data modeling language may be YANG. Through the setting by using the data modeling language, the external controller 140 may control the VM of the server 130.

As described above, the server 130 may be present in a plural number, and integrated control for the plurality of servers may be required. Since the control functions are separated, the gateway function of the plurality of servers may be controlled in a centralized manner through the SDN concept. The controller 140 may control the VMs of the plurality of servers in a centralized manner.

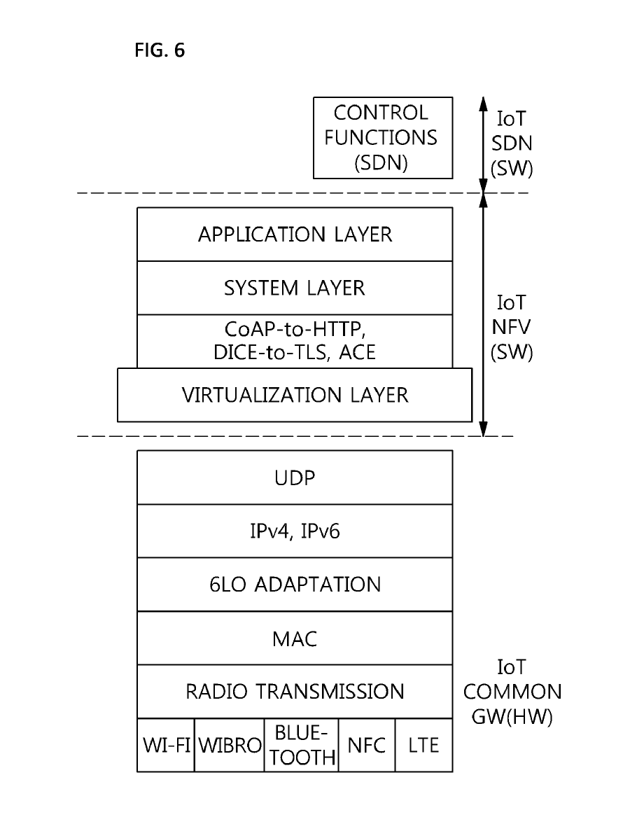

FIG. 6 illustrates a gateway function for supporting the end-to-end networking of resource-constrained nodes according to another embodiment of the present invention.

In FIG. 6, the gateway functions are divided into three regions by the dashed lines. Each region may represent the entity of the system in which that part of the gateway function is implemented.

In the gateway 120, UDP or lower layer entities, among entities for providing a gateway function, may be implemented. In the gateway 120, at least one of 6lo adaptation, IPv4, IPv6, and UDP may be implemented. The IoT common GW may correspond to at least one of the interface, radio transmission, MAC, 6lo adaption, IPv4, IPv6, and UDP. For example, the IoT common GW may include at least one of the physical layer, link layer, 6lo adaptation layer, network layer and transport layer.

The IoT common GW may be implemented in hardware and software. Furthermore, in the gateway 120, IPv6 and 6lo adaptation may also be implemented, in addition to software related to interfaces provided in the gateway 120. For example, in the gateway 120, software related to the first and second interfaces 320 and 330, IPv6, and 6lo adaptation may be implemented. Performance may be improved by the IPv6 and 6lo adaptation implemented in the gateway 120, and rapid connectivity between the node 110 and gateway 120 may be ensured.

The interface-related software may be software for an interface-dependent entity among entities for providing the gateway function. For example, the interface-related software may include radio transmission software and MAC software.

The IoT NFV may represent a gateway function provided by the server 130 in order to support end-to-end networking of the resource-constrained nodes. The IoT NFV may be a gateway function implemented in the server 130.

The IoT NFV may correspond to at least one of CoAP-to-HTTP, DICE-to-TLS, ACE, a system layer, and an application layer.

The IoT NFV may be a gateway function implemented in the server 130. In the server 130, entities of the application layer or lower layers, and entities of the transport layer or upper layers, among entities for providing the gateway function, may be implemented.

The IoT NFV may be implemented in software. The IoT NFV may be implemented as a VM. In other words, the server 130 may provide the IoT NFV as the VM driven in the server 130. For the VM, the server 130 may provide a virtualization layer. The IoT NFV may be implemented so as to operate in the virtualization layer. That is, the IoT NFV may be implemented in the virtualization layer. The VM provided by the server 130 may be present in a plural number. Each of the plurality of VMs may provide a part of the gateway function. The parts of the gateway function provided by each of the plurality of VMs may be different from each other. For example, each of the plurality of VMs may respectively provide CoAP-to-HTTP and DICE-to-TLS mapping.

The control functions described with reference to FIG. 1 may be separate from the gateway 120 and the server 130. The IoT SDN may represent control functions required in order to support the end-to-end networking of the resource-constrained nodes. The IoT SDN may be control functions implemented in the controller 140.

The controller 140 may externally control the VM of the server 130 through the control functions. Such control may include installation, connection, management, setting, configuration, operation, etc. The controller 140 may control 6lo adaptation, CoAP-to-HTTP, and DICE-to-TLS mapping through the control functions.

The control functions may be set through a data modeling language. For example, the data modeling language may be YANG. Through setting by using the data modeling language, the VM of the server may be controlled by the external controller 140.

As described above, the server 130 may be present in a plural number, and integrated control for the plurality of servers may be required. As the control functions are separated, the gateway functions of the plurality of servers may be controlled in a centralized manner through the SDN concept. The controller 140 may control the VMs of the plurality of servers in a centralized manner.

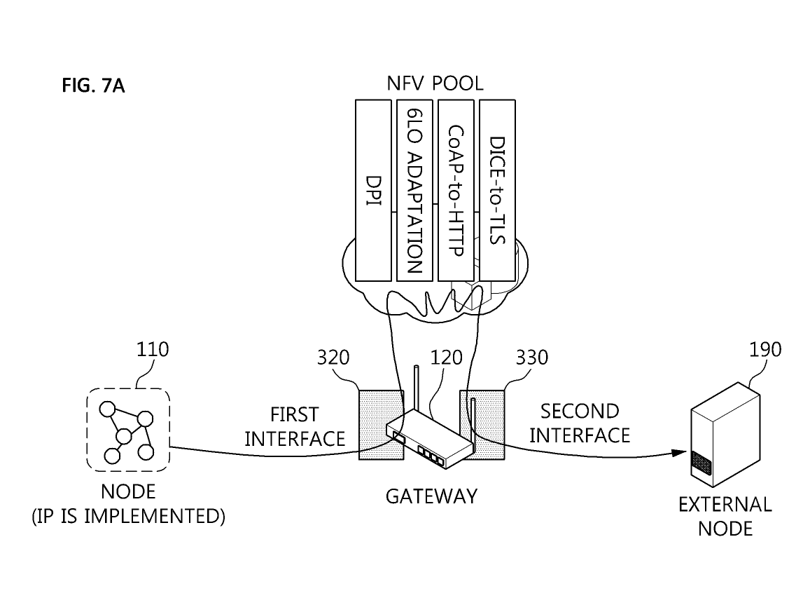

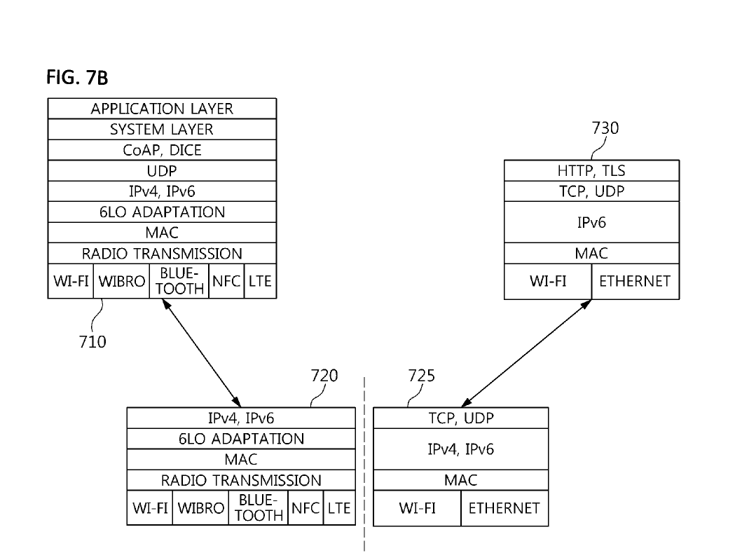

FIGS. 7A and 7B illustrate communication entities and networking functions of the entities in the case where a node according to an embodiment of the present invention directly supports an IP connection.

FIG. 7A illustrates communication entities according to an embodiment of the present invention.

The node 110 may be an IoT thing.

In the node 110, an IP may be implemented. In other words, the node 110 may directly support an IP connection.

The gateway 120 may be an IoT GW. The first interface 320 may be used for communication with the node 110. The second interface 330 may be used for communication with the external node 190.

When the node 110 directly supports the IP connection, for example, the first interface 320 may be a Bluetooth, WPAN, or NFC interface on IPv6. For example, the second interface 330 may be an IPv6 interface.

The external node 190 may be a node on a global network such as the Internet. For example, the external node 190 may be an external data server.

An NFV pool may represent a cloud that is a pool of the NFV. The cloud may include the server 130. As illustrated in the drawing, for communication from the node 110 to the external node 190, four entities of the NFV pool may process packets in sequence.

When the node 110 tries to communicate with the external node 190, the node 110 may first communicate with the first interface 320 of the gateway 210. The node 110 may transmit a packet to the first interface 320. When the packet is transmitted, the first interface 320 may forward the packet to the NFV pool.

After the forwarding, a mapping function to be processed by the gateway function for the packet may be processed by NFV type software. The DPI, 6lo adaptation, CoAP-to-HTTP mapping, DICE-to-TLS mapping, etc. may sequentially form a service chain, and the packet may be processed by the service chain. When the process is completed, the packet may be forwarded to the second interface 320. Then, the packet may be transmitted to the external node 190.

FIG. 7B illustrates the networking function of each entity according to an embodiment of the present invention.

A first table 710 may represent a networking function of the node 110. A second table 720 may represent a networking function implemented by the gateway 120 for the first interface 320. A third table 725 may represent a networking function implemented by the gateway 120 for the second interface 330. A fourth table 730 may represent a networking function of the external node 190.

In the node 110, the IP is implemented. When the node 110 directly supports an IP connection, the node 110 may implement all of 6lo adaptation, IPv6, UDP, CoAP, and DICE, etc. in addition to an interface and a protocol for the interface. The protocol for the interface may mean a communication protocol such as Bluetooth, NFC, etc.

On the other hand, for the first interface 320, the interface, protocol for the interface, 6lo adaptation, IPv4, and IPv6, etc. may be implemented according to the manner proposed in the embodiment.

For the second interface 330, entities for general wireless communication or wired communication may be implemented. The external node 190 may also implement entities for general wireless communication or wired communication.

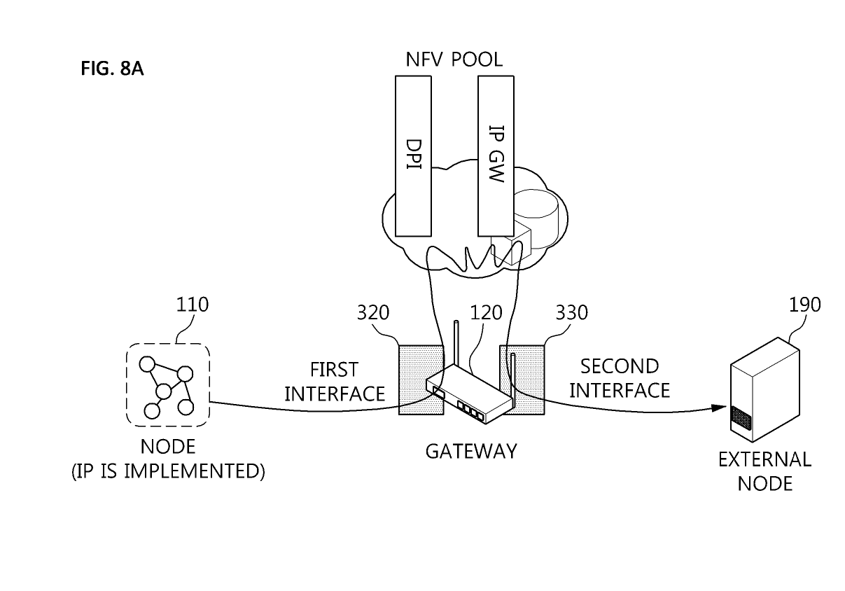

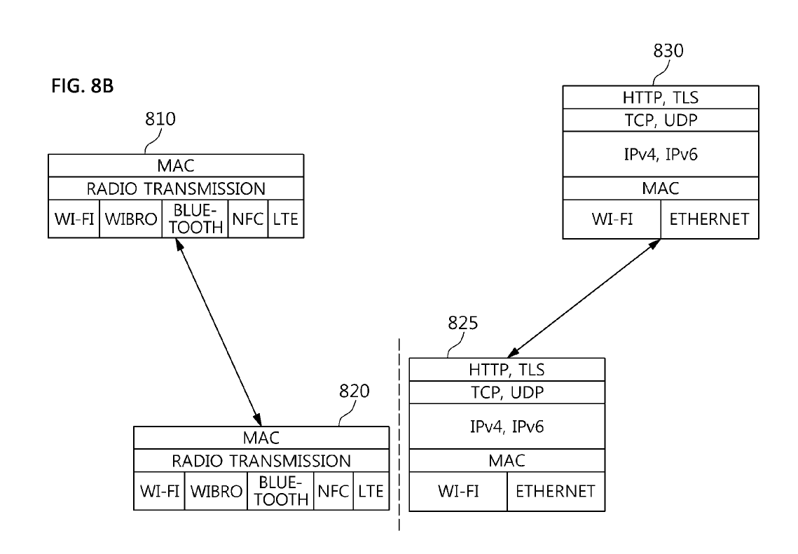

FIGS. 8A and 8B illustrate communication entities and networking functions of the entities in the case where a node according to an embodiment of the present invention does not directly support an IP connection.

FIG. 8A illustrates communication entities according to an embodiment of the present invention.

The node 110 may be an IoT thing.

In the node 110, an IP may not be implemented. In other words, the node 110 may be a non-IP thing, and the node 110 may not directly support an IP connection.

The gateway 120 may be an IoT GW. The first interface 320 may be used for communication with the node 110. The second interface 330 may be used for communication with the external node 190.

When the node 110 does not directly support the IP connection, for example, the first interface 320 may be a Bluetooth, WPAN, or NFC interface on IPv6. For example, the second interface 330 may be an IPv6 interface.

The external node 190 may be a node on a global network such as the Internet. For example, the external node 190 may be an external data server.

An NFV pool may represent a cloud that is a pool of the NFV. The cloud may include the server 130. As illustrated in the drawing, for communication from the node 110 to the external node 190, two entities of the NFV pool may process packets in sequence.

When the node 110 tries to communicate with the external node 190, the node 110 may first communicate with the first interface 320 of the gateway 210. The node 110 may transmit a packet to the first interface 320. When the packet is transmitted, the first interface 320 may forward the packet to the NFV pool.

After the forwarding, a mapping function to be processed by the gateway function for the packet may be processed by the NFV type software. The DPI, IPv6 GW, etc. may sequentially form a service chain, and the packet may be processed by the service chain. Here, the packet processing may include the generation of a new IP-based packet. When the process is completed, the new packet may be forwarded to the second interface 420. Then, the packet may be transmitted to the external node 190.

FIG. 8B illustrates the networking function of each entity according to an embodiment of the present invention.

A first table 810 may represent a networking function of the node 110. A second table 820 may represent a networking function implemented by the gateway 120 for the first interface 320. A third table 825 may represent a networking function implemented by the gateway 120 for the second interface 330. A fourth table 830 may represent a networking function of the external node 190.

In the node 110, the IP is not implemented. When the node 110 does not directly support the IP connection, the node 110 may implement an interface and a protocol for the interface in a physical layer. The protocol for the interface may mean a communication protocol such as Bluetooth, NFC, etc.

In addition, in order to correspond to the node 110 in which the IP is not implemented, an interface and a protocol for the interface may be implemented in the physical layer for the first interface 320.

For the second interface 330, entities for general wireless communication or wired communication may be implemented. The external node 190 may also implement entities for the general wireless communication or wired communication.

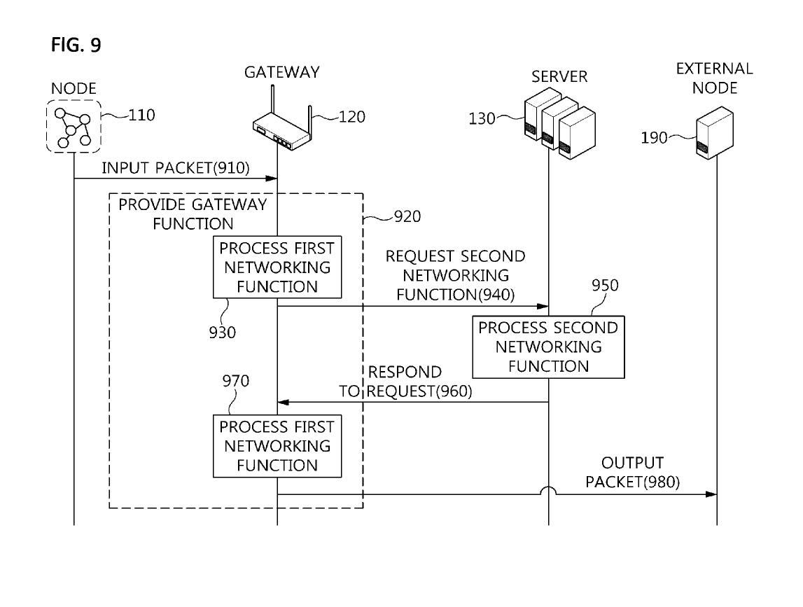

FIG. 9 is a flowchart of a method for providing a gateway function by a gateway and server according to an embodiment of the present invention.

In FIG. 9, the node 110 may transmit a packet to the external node 190, and the gateway 120 and the server 130 may provide a gateway function to the node 110.

At step 910, the node 110 may transmit the packet to the gateway 120. The gateway 120 may receive an input packet through the first interface 320.

The first interface 320 may be a wireless network interface.

At step 920, the processing unit 310 of the gateway 120 may provide the gateway function for the input packet by using a first networking function provided by the gateway 120 and a second networking function provided by the server 130.

The first networking function may be the gateway function of the IoT common GW, described with reference to FIG. 5, and the second networking function may be the gateway function of the IoT NFV, described with reference to FIG. 5. For example, the first networking function may include the MAC. Alternatively, the first networking function may be a function of the MAC or lower layers. For example, the second networking function may include the 6lo adaptation. Alternatively, the second networking function may be a function of the 6lo adaptation or upper layers.

Alternatively, the first networking function may be the gateway function of the IoT common GW, described with reference to FIG. 6, and the second networking function may be the gateway function of the IoT NFV, described with reference to FIG. 6. For example, the first networking function may include at least one of the UDP and TCP. Alternatively, the first networking function may be a function of the UDP or lower layers, or the TCP or lower layers. For example, the second networking function may include at least one of the CoAP-to-HTTP, DICE-to-TLS and ACE mapping functions. Alternatively, the second networking function may be a function of the layer of at least one of the CoAP-to-HTTP, DICE-to-TLS and ACE mapping functions or lower layers.

As described with reference to FIGS. 7A and 7B, the node 110 may directly support the IP connection. When the node 110 may directly support the IP connection, the first networking function may include at least one of the IPv4 and IPv6. Alternatively, the first networking function may be a function of at least one of the IPv4 and IPv6 layers or lower layers.

As described with reference to FIGS. 8A and 8B, the node 110 may not directly support the IP connection. When the node 110 does not directly support the IP connection, the first networking function may include the MAC. Alternatively, the first networking function may be a function of the MAC or lower layers. Alternatively, when the node 110 does not directly support the IP connection, the second networking function may include the 6lo adaptation. Alternatively, the second networking function may be a function of the 6lo adaptation or upper layers.

As described with reference to FIGS. 7B and 8B, a networking function provided for the first interface 320 and a networking function provided for the second interface 330 may be different from each other.

The server 130 may provide the second networking function in an NFV manner. Alternatively, the second networking function may be provided on the virtualization layer provided by the server 130.

In addition, the server 130 may be a cloud server, namely, one of the cloud servers providing the NFV pool. The NFV pool may represent the second networking function provided in the NFV manner.

According to the use of the NFV pool, the processing capacity of the cloud may be expanded by adding a new server, which provides the second networking function, to the cloud or by installing the second networking function on a new server.

Step 920 may include at least a part of steps 930, 940, 950, 960, 970, and 980.

At step 930, the processing unit 310 of the gateway 120 may process the first networking function. For example, the processing unit 310 may process the first networking function for an input packet.

At step 940, the gateway 120 may transmit a request for the second networking function for the input packet to the server 130 through the second interface 330.

The communication unit 420 of the server 130 may receive the request for the second networking function for the input packet from the gateway 120.

The request may include the input packet or data of the input packet. Alternatively, the request may include a processing result at step 930.

At step 950, the processing unit 410 of the gateway 130 may process the second network function in response to the request.

The gateway function for the input packet may be provided by the first and second networking functions provided by the gateway 120.

At step 960, the communication unit 420 of the server 130 may transmit a response to the request to the gateway 120.

The gateway 120 may receive the response to the request from the second interface 330 through the second interface 330.

The response may include a processing result at step 950.

At step 970, the processing unit 310 of the gateway 120 may process the first network function for the response or the result transmitted from the server 130.

At step 980, the gateway 120 may transmit an output packet to the external node 190 through the second interface 330.

The output packet may be generated by applying the gateway function at step 920 to the input packet. In an example, the input packet and the output packet may be identical. Alternatively, the data in the input packet and the data in the output packet may be identical. Alternatively, the output packet may correspond to the input packet.

For example, the output packet may be the response transmitted at step 960, and may be data included in the response. In other words, at step 960, the response transmitted from the server 130 may include the output packet or data of the output packet. At step 960, the processing unit 410 of the server 130 may transmit, as the response to the request, the output packet to the second interface 330 of the gateway 120. Alternatively, at step 980, the second interface 330 may transmit the output packet to the external node 190.

Alternatively, the output packet may be generated by the process at step 970. For example, at step 960, when the gateway 120 receives the result of the request from the server 130, at step 970, the processing unit 310 may generate an output packet based on the result.

Through the steps 910 and 920, the gateway 120 may process the input packet in software through a mapping function of a virtualized type regardless of whether the input packet is an IP packet or a non-IP packet by forwarding the input packet to the server 130 regardless of whether the input packet is an IP packet or a non-IP packet.

Content on the above-described embodiments in relation to FIGS. 1 to 8B may be applied to the present embodiment. Hereinafter, repetitive explanations will be omitted.

According to the above-described embodiments, various interfaces to be diversely implemented in the gateway and mapping functions related thereto may be implemented more simply. Through this implementation, development costs and software costs may be reduced.

In addition, according to the above-described embodiments, when it is required to upgrade software due to a new function such as a standardized new protocol in the low-power resource-constrained networking environment, the new function may be supported without upgrading gateway hardware, that is, merely by upgrading software in the cloud. Through this support, end-to-end global networking may be more extensively and flexibly provided.

In addition, when the number of nodes is increased, it is necessary to additionally install a physical hardware gateway or physically relocate the gateway in order to smoothly support node communication. According to the above-described embodiments, processing capacity may be expanded without such additional installation and relocation, merely by adding a server for providing the gateway function to the cloud. The server addition may be performed by, for example, additionally installing software for the network function pool to the server. In other words, a scale-out function may be smoothly supported merely by installing software on a server in the cloud.

In addition, a packet received by the gateway may be an IP-supporting packet or a non-IP packet. The gateway may process the received packet in software by calling a mapping function of an NFV type in the cloud, regardless of whether the received packet is an IP support packet or a non-IP packet. Accordingly, for the gateway, various IoT processing methods may be more flexibly provided.

In addition, the gateway may support the NFV concept in providing the gateway function. The gateway may process the received packet in software through a mapping function of a virtualized type regardless of whether the received packet is an IP support packet or a non-IP packet by unconditionally forwarding the received packet to the cloud providing the NFV pool.

The above-described various embodiments of the present invention may be implemented as program instructions to be stored in a computer-readable storage medium. The computer readable recording medium may include program instructions, data files, and data structures independently or in a combined manner. The program instructions recorded on the computer readable recording medium is particularly designed and configured for the present invention, but may be known to those skilled in the art of computer software field to be useable. Examples of the computer readable recording medium include a magnetic medium including a hard disk, floppy disk, and magnetic tape, an optical recording medium such as a CD-ROM and DVD, magneto-optical media such as a floptical disk, and a hardware device particularly configured to store and execute the program instructions such as ROM, RAM, and flash memory. Program instructions may include high-level language code executable by a computer using an interpreter in addition to machine code created by a complier. The hardware device may be configured to operate as at least one software module to perform an operation of various embodiments and vice versa.

As described above, the present invention provides an apparatus and method for implementing a gateway function, required in IPv6, over a network of resource-constrained nodes.

The present invention also provides an apparatus and method for supporting interaction with a global network such as the Internet in a low-power, resource-constrained networking environment such as the IoT.

The present invention also provides an apparatus and method for more extensively and flexibly supporting interaction with a global network such as the Internet in a low-power, resource-constrained networking environment.

The present invention also provides an apparatus and method for processing a gateway function through an NFV concept.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims.

Therefore, those skilled in the art will appreciate that various modifications and other equivalent embodiments are possible from the embodiments. Therefore, the technical scope of the present invention should be defined by the technical spirit of the claims.

What is claimed is:

1. A method for providing, by a gateway, a gateway function, the method comprising:
receiving an input packet from a node; and
providing the gateway function for the input packet by using a first networking function provided by the gateway and a second networking function provided by a server.

2. The method as set forth in claim 1, wherein:
the gateway receives the input packet from the node through a first interface of the gateway, and
the first interface is a wireless network interface.

3. The method as set forth in claim 1, wherein providing the gateway function comprises transmitting an output packet, generated by applying the gateway function to the input packet, to an external node through a second interface of the gateway.

4. The method as set forth in claim 3, wherein the server transmits the output packet to the second interface, and the second interface transmits the output packet to the external node.

5. The method as set forth in claim 3, wherein a networking function provided for the first interface and a networking function provided for the second interface are different from each other.

6. The method as set forth in claim 1, wherein providing the gateway function further comprises:
transmitting, to the server, a request for the second networking function for the input packet;
receiving a processing result to the request from the server; and
generating the output packet based on the processing result.

7. The method as set forth in claim 1, wherein the first networking function comprises media access control (MAC), and
the second networking function comprises 6lo adaptation.

8. The method as set forth in claim 1, wherein the first networking function comprises User Datagram Protocol (UDP), and
the second networking function comprises at least one of CoAP-to-HTTP, DICE-to-TLS and ACE mapping functions.

9. The method as set forth in claim 1, wherein the node does not directly support an IP connection, the first networking function comprises MAC, and the second networking function comprises an IP.

10. The method as set forth in claim 1, wherein the server provides the second networking function in a network function virtualization (NFV) type.

11. The method as set forth in claim 1, wherein the second networking function is provided on a virtualization layer provided by the server.

12. The method as set forth in claim 1, wherein the server is one of a plurality of cloud servers providing an NFV pool.

13. The method as set forth in claim 12, wherein a processing capacity of a cloud is expanded by adding a new server, which provides the second networking function, to the cloud.

14. The method as set forth in claim 1, wherein the gateway processes the input packet in software through a mapping function in a virtualized manner regardless of whether the input packet is an IP packet or a non-IP packet by forwarding the input packet to the server regardless of whether the input packet is an IP packet or a non-IP packet.

15. A gateway comprising:
a first interface receiving an input packet from a node;
a second interface transmitting an output packet to an external node; and
a processing unit providing a gateway function for the input packet by using a first networking function provided by the gateway and a second networking function provided by a server,
wherein the output packet is generated by applying the gateway function to the input packet.

16. A method for providing, by a server, a gateway function, the method comprising:
receiving, from a gateway, a request for a first networking function for an input packet received by the gateway;
processing the first networking function corresponding to the request; and
transmitting a response to the request to the gateway,
wherein the gateway function for the input packet is provided by a second networking function provided by the gateway and the first networking function.

17. The method as set forth in claim 16, wherein the second networking function comprises MAC, and the first networking function comprises 6lo adaptation.

18. The method as set forth in claim 16, wherein the second networking function comprises UDP, and the first networking function comprises at least one of CoAP-to-HTTP, DICE-to-TLS, and ACE mapping functions.

19. The method as set forth in claim 16, wherein the server provides the first networking function in an NFV type.

20. The method as set forth in claim 16, wherein the server is one of cloud servers providing an NFV pool.
